(19) United States
(12) Patent Application Publication
(10) Pub. No.: US 2025/0266876 A1
(43) Pub. Date: Aug. 21, 2025

(54) BEAMFORMING TECHNIQUES FROM NON-UNIFORM ARRAYS

(71) Applicants: F Jeffrey Scott Arndt, Fairfax, VA (US); Lauren Nichole Kight, Lincolnton, GA (US)

(72) Inventors: F Jeffrey Scott Arndt, Fairfax, VA (US); Lauren Nichole Kight, Lincolnton, GA (US)

(21) Appl. No.: 19/049,833

(22) Filed: Feb. 10, 2025

Related U.S. Application Data
(60) Provisional application No. 63/555,300, filed on Feb. 19, 2024.

(51) Int. Cl. H04B 7/06; H04L 41/16

(52) U.S. Cl. CPC H04B 7/0617; H04L 41/16

(57) ABSTRACT

Systems and methods are provided for generating weights for a non-uniform array. Control circuitry for the non-uniform array may receive an indication that signals transmitted by the non-uniform array should be modified to improve similarity to a specified beam pattern. The control circuitry may select a subset of potential parameters with a first genetic algorithm. Based on these parameters, the control circuitry may generate weights for the non-uniform array with a second genetic algorithm, where each determined weight impacts signal output by an element of the antenna array or other machine learning techniques can be used. The control circuitry may apply the weights to the non-uniform array.

### CROSS-REFERENCE TO RELATED APPLICATIONS

This application claims the benefit of U.S. Provisional Application Ser. No. 63/555,300, filed Feb. 19, 2024, titled “BEAMFORMING TECHNIQUES FROM NON-UNIFORM ARRAYS,” which is incorporated by reference herein in its entirety.

### FIELD

The disclosed technology generally relates to improved transmit and receive beamforming techniques for antenna arrays.

### BACKGROUND

Traditional beamforming techniques can adjust the frequency and phase of transmitted signals in order to achieve a signal corresponding to specified beam patterns. Traditional techniques may also process a received signal to account for non-idealities, such as noise, in a received signal. These techniques typically require the transmit and receive antenna arrays to behave in an expected manner and require a priori knowledge of non-uniformities in an array or array elements and may not be possible to implement with non-uniform arrays or arrays with unknown non-uniformities.

### SUMMARY

Various embodiments of systems, methods, and devices within the scope of the appended claims each have several aspects, no single one of which is solely responsible for the desirable attributes described herein. Without limiting the scope of the appended claims, some prominent features are described herein.

In some aspects, the techniques described herein relate to a computer-implemented method including: obtaining a beam pattern to be transmitted by an antenna array; determining, using one or more machine learning algorithms such as a two-step genetic algorithm or other machine learning algorithm, parameters for selecting weights for the antenna array; determining, using the one or more machine learning algorithms, one or more weights for the antenna array, wherein each determined weight impacts signal output by an element of the antenna array; and applying the determined weights to control circuitry of the antenna array.

In some aspects, the techniques described herein relate to a computer-implemented method, wherein the one or more machine learning algorithms implement an appropriate technique such as a two-step genetic algorithm.

In some aspects, the techniques described herein relate to a computer-implemented method, wherein the one or more machine learning algorithms include a first genetic algorithm and a second genetic algorithm, wherein the first genetic algorithm determines the one or more weights for the antenna array, and wherein the second genetic algorithm determines the parameters for selecting weights.

In some aspects, the techniques described herein relate to a computer-implemented method, further including causing the antenna array to transmit a signal in accordance with the determined weights.

In some aspects, the techniques described herein relate to a computer-implemented method, further including: receiving the signal with a second antenna array including one or more elements; applying at least one windowing technique to the received signal; selecting a minimum value; and displaying the received signal.

In some aspects, the techniques described herein relate to a method, wherein at least one element of the second antenna array is damaged.

In some aspects, the techniques described herein relate to a computer-implemented method, wherein determining parameters includes selecting a subset of parameters for consideration including at least one of minimum side lobe levels, maximum side lobe levels, null depth, beamwidth, signal to noise ratio, signal strength, and interference.

In some aspects, the techniques described herein relate to a computer-implemented method, wherein determining parameters includes determining a target range for the selected subset of parameters.

In some aspects, the techniques described herein relate to a computer-implemented method, further including providing input to the first genetic algorithm including mutation, crossover number of generations to determine parameters meeting thresholding criteria.

In some aspects, the techniques described herein relate to a computer-implemented method, further including providing input to second genetic algorithm including mutation, crossover, or number of generations to determine the weights.

In some aspects, the techniques described herein relate to any system that uses an array, such as a communication system including: a first antenna array including one or more elements, wherein at least one element of the first antenna array is damaged; and control circuitry in communication with the antenna array, wherein the control circuitry is configured to dynamically adjust weights for the first antenna array to achieve transmission of a specified beam pattern at least by: determining weights for the first antenna array using a first algorithm; and determining parameters for selecting weights of the first antenna array using a second algorithm.

In some aspects, the techniques described herein relate to a system, wherein the first algorithm and the second algorithm include genetic algorithms.

In some aspects, the techniques described herein relate to a system, further including: a second antenna array including one or more elements; and second control circuitry in communication with the second antenna array, wherein the second control circuitry is configured to dynamically adjust weights for the second antenna array to receive signals from the first antenna array.

In some aspects, the techniques described herein relate to a system, wherein the first antenna array is a linear antenna array.

In some aspects, the techniques described herein relate to a system, wherein the first antenna array is a sparse antenna array.

In some aspects, the techniques described herein relate to a system, wherein the first antenna array is conformal.

In some aspects, the techniques described herein relate to a system, wherein the one or more elements of the first antenna array are arbitrarily spaced.

In some aspects, the techniques described herein relate to a system, wherein the one or more elements of the first antenna array are equidistant.

In some aspects, the techniques described herein relate to a computer-implemented method including: receiving a signal with an antenna array, wherein at least one element of the antenna array is damaged, non-ideally oriented, or has unknown performance parameters; determining weights to apply to the antenna array; interpreting received signal by at least: applying an apodization method to the received signal; and displaying the received signal.

In some aspects, the techniques described herein relate to a computer-implemented method, wherein applying an apodization method includes applying a linear apodization method.

In some aspects, the techniques described herein relate to a computer-implemented method, wherein applying an apodization method includes applying a non-linear apodization method.

In some aspects, the techniques described herein relate to a computer-implemented method, wherein applying a non-linear apodization method that includes at least one of dual-apodization, tri-apodization, or quad-apodization.

In some aspects, the techniques described herein relate to a computer-implemented method, wherein applying the non-linear apodization includes: applying a plurality of different windowing techniques to obtain a plurality of output signals; and selecting a minimal carrier-to-noise (CNR) value of the plurality of output signals.

In some aspects, the techniques described herein relate to a computer-implemented method, wherein applying the plurality of windowing techniques such as one of a rectangular window, a Dolph-Chebyshev window, and a Kaiser Window.

In some aspects, the techniques described herein relate to a computer-implemented method, further including: receiving an indication that a second antenna array, including one or more elements, is damaged, non-ideally oriented or has arbitrary performance parameters; obtaining a specified beam pattern to be received by the antenna array; receiving a signal including the specified beam pattern; determining parameters for selecting weights for the antenna array with a first genetic algorithm; based on the determined parameters, determining weights for the damaged antenna array with a second genetic algorithm, wherein the each determined weight impacts the signal received by an element of the antenna array; and applying the determined weights to the second antenna array.

In some aspects, the techniques described herein relate to any system that uses an array such as a communication system including: an antenna array including one or more elements, wherein at least one element of the antenna array is damaged; and control circuitry in communication with the antenna array, wherein the control circuitry is configured to dynamically adjust weights for the antenna array for receiving a signal by at least: applying an apodization method to the received signal; and displaying the received signal.

In some aspects, the techniques described herein relate to a system, wherein the control circuitry is further configured dynamically adjust weights for the antenna array by applying one or more weight determination algorithms, wherein the one or more weight determination algorithms include optimization techniques such as genetic algorithms.

In some aspects, the techniques described herein relate to a system, further including: a second antenna array including one or more elements; and second control circuitry in communication with the second antenna array elements, wherein the second control circuitry is configured to dynamically adjust weights for the second antenna array to receive signals from the antenna array.

In some aspects, the techniques described herein relate to a system, wherein the antenna array is a linear antenna array.

In some aspects, the techniques described herein relate to a system, wherein the antenna array is a sparse antenna array.

In some aspects, the techniques described herein relate to a system, wherein the antenna array is conformal and deformable.

In some aspects, the techniques described herein relate to a system, wherein the one or more elements of the antenna array have arbitrary performance parameters.

### BRIEF DESCRIPTION OF THE DRAWINGS

Embodiments of various inventive features will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1A illustrates an example system for transmission and/or receipt of signals by antenna arrays.

FIG. 1B illustrates an example system for transmission and/or receipt of signals by an antenna array.

FIGS. 2A-2C illustrate example antenna arrays in accordance with the present disclosure.

FIGS. 3A-3B illustrate example distortions in a received signal.

FIG. 4 illustrates example parameters associated with the receipt of signals by an antenna array.

FIG. 5 illustrates an example weight determination method for implementing an algorithm to improve beamforming with respect to non-uniform arrays in accordance with the present disclosure.

FIG. 6 illustrates an example method for transmitting a specified beam pattern in accordance with the present disclosure.

FIG. 7 illustrates an example method for processing a signal in accordance with the present disclosure.

FIG. 8 schematically illustrates example control circuitry in accordance with the present disclosure.

### DETAILED DESCRIPTION

The present disclosure will now be described with reference to the accompanying figures, wherein like numerals refer to like elements throughout. The following description is merely illustrative in nature and is in no way intended to limit the disclosure, its application, or uses. It should be understood that steps within a method may be executed in different order without altering the principles of the present disclosure. Furthermore, the devices, systems, and/or methods disclosed herein can include several novel features, no single one of which is solely responsible for its desirable attributes, or which is essential to practicing the devices, systems, and/or methods disclosed herein.

Generally described, the present application relates to systems and methods for transmitting and/or receiving a signal using an array with one or more unknown array parameters. Some aspects of the present disclosure correspond to systems and methods for determining weights for transmit and receive beamforming of a signal for arrays with one or more unknown array parameters to improve communication (e.g., transmission or receipt) of a signal. Some aspects provide for the use of one or more weight determination algorithms.

Various aspects of the present disclosure can advantageously improve communication of a signal corresponding to beam patterns during use of non-uniform, damaged, and/or otherwise non-ideal arrays. Examples of non-uniformities, damage, or non-ideal aspects may include arrays with unequal spacing between the elements, elements at different orientations with respect to each other (e.g., curved, non-parallel, etc.), elements that are damaged, inoperable, or operating at reduced power, with unequal power supplied to individual elements, and elements with varying look directions. Additionally, or alternatively, some aspects of the present disclosure may improve longevity of damaged arrays by improving their ability to transmit and/or receive at an acceptable level.

Antenna technology is evolving to increase complexity and incorporate new techniques, such as sparsity or interleaving techniques. These techniques may result in an increase in unknown array parameters, such as those relating to the layout and performance of elements within antenna arrays. Array parameters may include, but are not limited to, element spacing, element angle, variance in power supplied to individual elements, or variance in power received by individual elements. Removal of elements in an arbitrary array may also result in unknown array parameters. For example, if four random elements of a simple thirty-two element linear array are damaged, a transmitted or received beam pattern may be significantly altered with respect to a specified beam pattern. Damage to antenna arrays also introduces a variety of unknown antenna parameters. Traditional beamforming techniques are not able to account for array parameters that are unknown to improve the ability of non-uniform or damaged arrays to transmit or receive a signal corresponding to specified beam patterns.

Some aspects of the present disclosure address some or all of the issues noted above by use of one or more weight determination algorithms to generate weights for an antenna array or arrays. Weights can be used in transmitting or receiving signals corresponding to a specified beam patterns, such as to improve the directionality of the signal in a specified direction. Weights may specify the signal strength (e.g., amplitude) and/or phase for individual elements of an antenna array. Weights may apply during transmission and/or receipt of the signal in order to improve transmission of the information included in the signal by shaping the signal to correspond with specified beam patterns.

One example of a weight determination algorithm may be a genetic algorithm. A genetic algorithm is an adaptive heuristic search algorithm in the evolutionary algorithm family. It is based on the idea of natural selection, furthering desirable traits, and adding mutation to prevent premature convergence of solutions. A parameter determination genetic algorithm may be used to determine a set of performance parameters for use in determining weights that will result in the most improvement to the communication of a signal. After specified weights are determined, the weights may be applied to an antenna array and a signal corresponding to a specified beam pattern may be generated or received. Applications of weights and genetic algorithms will be discussed in greater detail herein.

In some embodiments, aspects of the present disclosure may maximize the utility of nontraditional hardware with various non-uniformities, allowing for improved performance from new equipment designs. This may include, for example, new and innovative ultra-wide bandwidth multi-functional phased array hardware, element designs, feed components and construction; sparse arrays, element, and aperture designs, especially on a curved surface. For example, performance in these arrays may be sensitive to slight mismatches of look direction, signal pointing, imperfect calibration of the array, signal to noise ratio (SNR), and distortions in the antenna shape. Systems and methods discussed herein may improve performance in a variety of signal processing applications including, but not limited to, radar imaging, ultrasound imaging, and communication arrays enabling the output of a signal/image.

Although aspects of some embodiments described in the disclosure will focus, for the purpose of illustration, on transmitting and receiving data with one or more antenna arrays and control circuitry, it will be understood that the present disclosure is not limited to these particular example implementations. One skilled in the relevant art will appreciate that the examples are illustrative only and are not necessarily intended to be limiting.

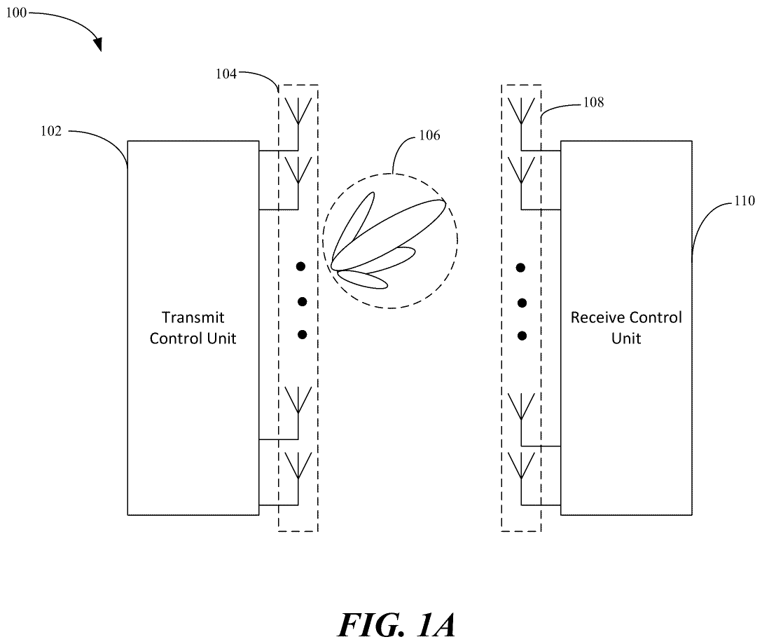

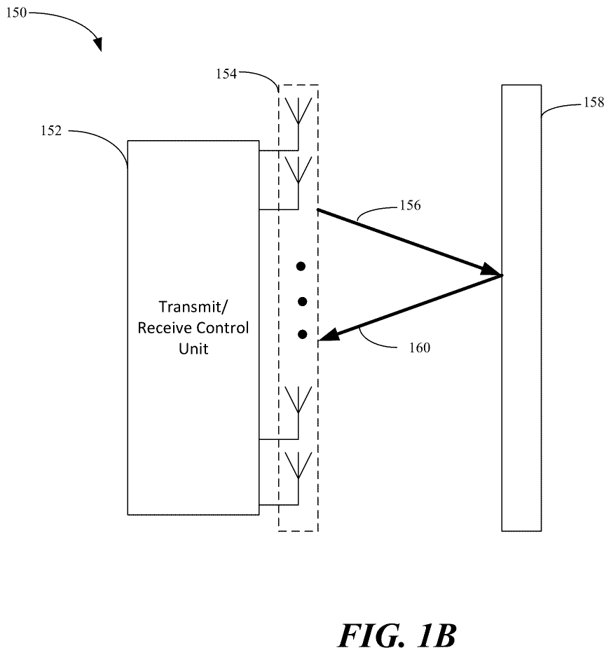

FIG. 1A illustrates an example system 100 for transmission of and/or receipt of signals by antenna arrays. The system 100 includes transmit control circuitry 102 associated with an antenna array 104, and/or receive control circuitry 110 associated with an antenna array 108.

The transmit control circuitry 102 may be in electronic communication with antenna array 104. For example, transmit control circuitry 102 may be connected to antenna array 104 via one or more wires or cables. Additionally, or alternatively, transmit control circuitry 102 may be connected to antenna array 104 remotely through a network. Transmit control circuitry 102 can include one computing device or can include a plurality of local or remote computing devices. The various calculation and control functions described herein with reference to transmit control circuitry 102 can be divided and performed by a combination of local and remote computing devices.

The receive control circuitry 110 may be in electronic communication with antenna array 108. For example, receive control circuitry 110 may be connected to antenna array 108 via one or more wires or cables. Additionally, or alternatively, receive control circuitry 110 may be connected to antenna array 108 remotely through a network. Receive control circuitry 110 can include one computing device or can include a plurality of local or remote computing devices. The various calculation and control functions described herein with reference to receive control circuitry 110 can be divided and performed by a combination of local and remote computing devices.

Various embodiments of the present disclosure can include more or fewer components than depicted in system 100. For example, in some embodiments a system for transmission of and/or receipt of signals by antenna arrays may include either transmit control circuitry 102 and antenna array 104 or receive control circuitry 110 and antenna array 108, or may include a single antenna array (e.g., antenna array 104 or 108) and associated control circuitry configured for both transmit and receive operations, as described further with respect to FIG. 1B.

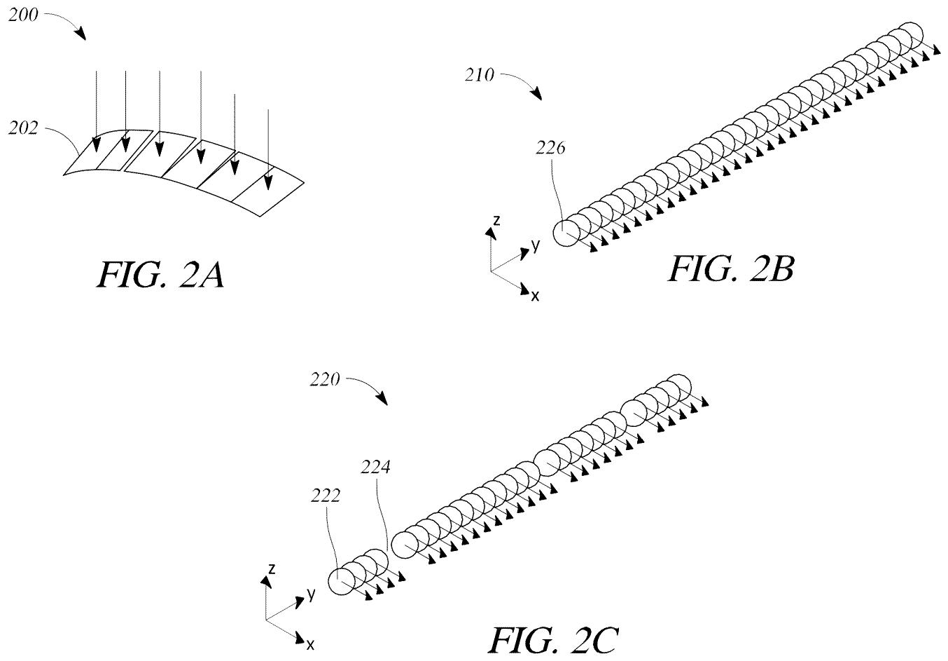

The transmit control circuitry 102 may generate a signal 106 with antenna array 104. The transmit control circuitry 102 may transmit instructions to the antenna array 104 to generate a signal corresponding to a specified beam pattern. The transmit control circuitry 102 may obtain the specified beam pattern from a user. For example, a user may provide instructions directly to the transmit control circuitry 102 through a user interface. However, in some embodiments, the user may provide instructions to the transmit control circuitry 102 through a network-connected device (e.g., a smartphone, a laptop, etc.) Components of the transmit control circuitry 102 will be discussed in more detail with reference to FIG. 2.

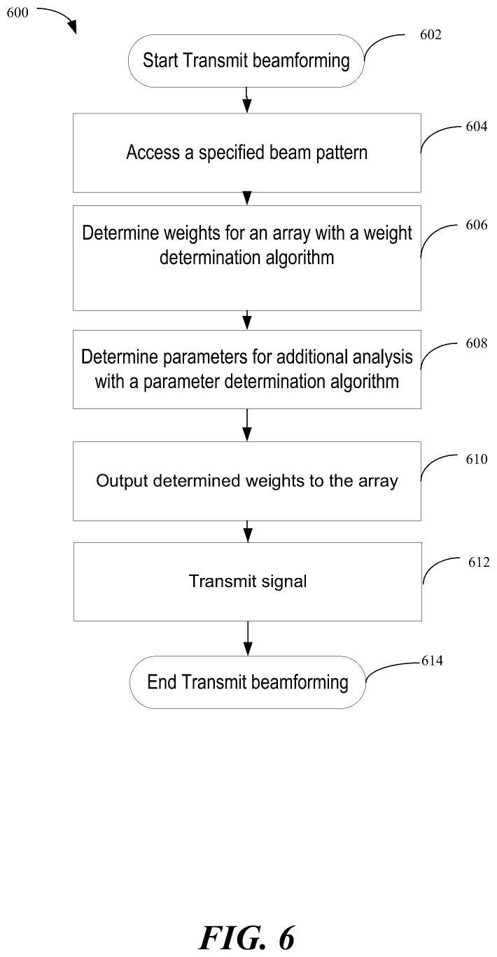

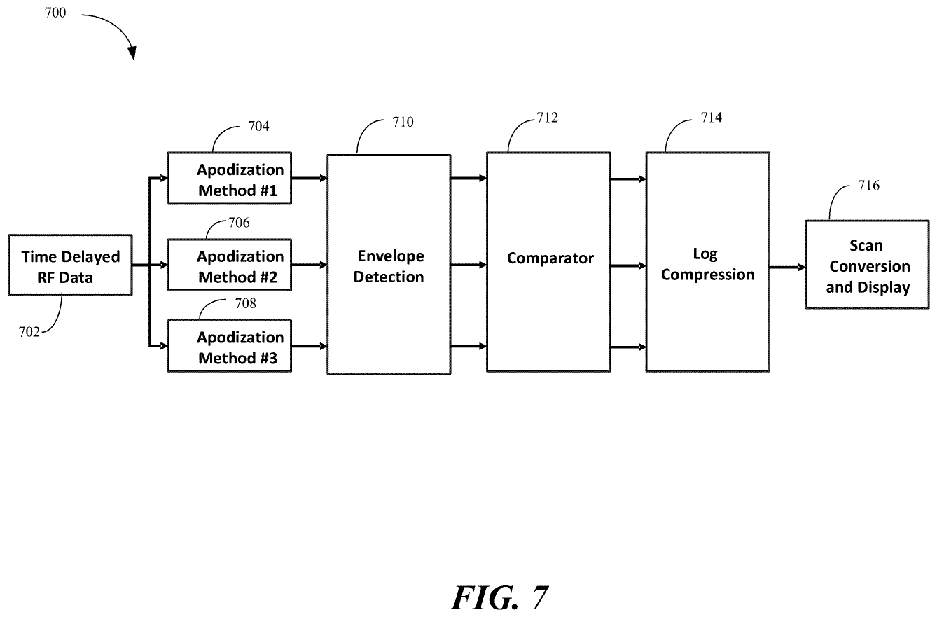

Antenna array 104 may be, but is not limited to, a uniform linear array (ULA), a uniform circular array (UCA), a rectangular array, a planar array, a phased array a conformal array, a smart antenna array, a multiple input multiple output (MIMO) array, a lattice array, or some combination thereof. Antenna array 104 may have fixed weights, where the weights assigned to each antenna element may be constant after initial application of the weights. Antenna array 104 may be an adaptive array, where an adaptive array is configured to dynamically adjust weights applied to each element of the array. Weights may be received from control circuitry, such as transmit control circuitry 102. Transmit control circuitry 102 may generate weights for the array using one or more weight determination algorithms, such as genetic algorithms. A genetic algorithm example is discussed in more detail with reference to FIGS. 6-7 below.

Antenna array 104 may include one or more array elements 105. In some embodiments, each element of array elements 105 may be able to emit signals at the same signal strength. However, in some embodiments, there may be variance in the signal strength that each element of the array elements 105 is able to emit. For example, in some embodiments, some elements of array elements 105 may be malfunctioning or damaged. These malfunctioning or damaged elements may only be able to emit a lesser signal strength with respect to the other elements of array elements 105.

Each element of array elements 105 might emit signals at greater or lesser signal strength with respect to other elements on command from transmit control circuitry 102. Transmit control circuitry 102 may specify greater or lesser signal strength for one or more elements to generate a signal with a pattern corresponding to a specified beam pattern. Transmit control circuitry 102 may also specify frequency and phase emitted by each element of the antenna array to generate signal corresponding to specified beam pattern.

In some embodiments, the transmit control circuitry 102 may determine a specified beam pattern to improve the performance of a signal in a specified direction, such as a direction corresponding to the location of a receiving antenna. The transmit control circuitry 102 may subsequently determine and/or implement control instructions specifying weights for each element of array elements 105 in order to generate a signal corresponding to the specified beam pattern. The weights for each element may include features such as signal strength, frequency, and phase.

Antenna array 108 may be, but is not limited to, a uniform linear array (ULA), a uniform circular array (UCA), a rectangular array, a planar array, a phased array, a conformal array, a smart antenna array, a multiple input multiple output (MIMO) array, a lattice array, or some combination thereof. Antenna array 108 may have fixed weights, where the weights assigned to each antenna element may be constant after initial application of the weights. Antenna array 108 may be an adaptive array, where an adaptive array is configured to dynamically adjust weights applied to each element of the array. Weights may be received from control circuitry, such as receive control circuitry 110. Receive control circuitry 102 may generate weights for the array using one or more weight determination algorithms. A genetic algorithm example is discussed in more detail with reference to FIGS. 6-7 below.

Antenna array 108 may include one or more array elements 109. In some embodiments, each element of array elements 109 may be able to receive signals at a signal strength corresponding to the strength of a signal arriving at the element. However, in some embodiments, there may be variance in the signal strength that each element of the array elements 109 is able to receive. For example, in a non-limiting embodiment, some elements of array elements 109 may be malfunctioning or damaged. These malfunctioning or damaged elements may only be able to receive a lesser signal strength with respect to a signal arriving at the respective element(s).

As another example, each element of array elements 109 might receive signals at lesser signal strength with respect to other elements on command from receive control circuitry 110. Receive control circuitry 110 may apply weights to an element to amplify or suppress signal strength with respect to a signal arriving at the element to capture a signal in accordance with a specified beam pattern. Receive control circuitry 110 may also specify frequency and phase emitted by each element of the antenna array to capture a signal with a pattern corresponding to specified beam pattern. The specified beam pattern for receiving a signal may differ from a specified beam pattern for transmission. Alternately, specified beam pattern for receiving a signal may be substantially similar to a specified beam pattern for transmission.

In a non-limiting embodiment, the receive control circuitry 110 may determine a specified beam pattern to improve the performance of a signal in a specified direction, such as a direction corresponding to the location of a transmitting antenna and/or the incoming signal. The receive control circuitry 110 may subsequently determine and/or implement control instructions specifying weights for each element of array elements 109 in order to capture a signal corresponding to the specified beam pattern. The weights for each element may include at least one of signal strength, frequency, and phase.

In some embodiments, array elements 105 or array elements 109 may be non-uniform, increasing the difficulty in specifying weights to generate a signal corresponding to a specified beam pattern. For example, antenna elements in an antenna array (e.g., antenna elements 105, array elements 109, etc.) may be non-uniform if they are on a curved surface, have non-uniform spacing, have differing orientations (e.g., not parallel, differing angles, etc.), or have different power characteristics (e.g., different transmit (Tx) power, different receive (Rx) power, etc.). Arrays may be non-uniform if they are not equally spaced have different look directions, have differing amounts of gain, imperfect calibration, and the like, or some combination thereof Arrays may also be non-uniform if damaged or malfunctioning.

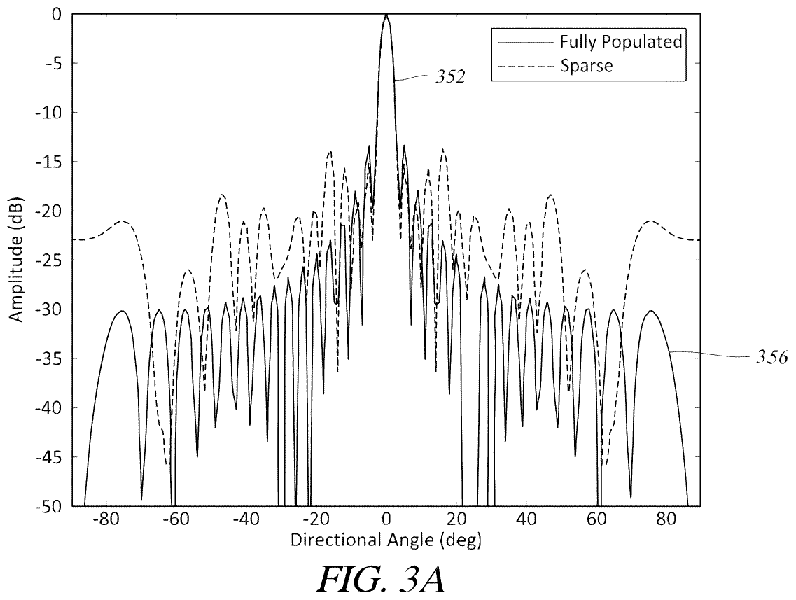

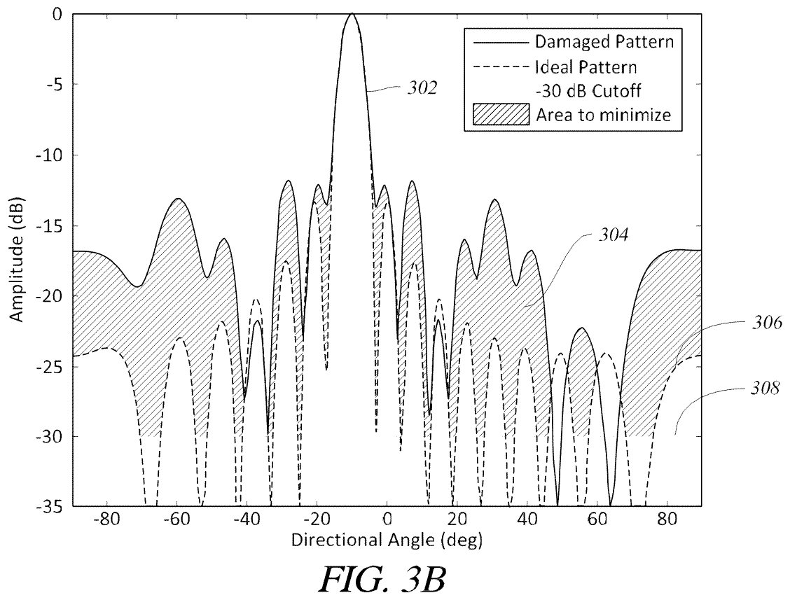

Arrays may also be intentionally non-uniform (e.g., to improve performance in certain applications). For example, non-uniform antenna designs may include, but are not limited to sparse arrays, conformal arrays, deformable arrays, and innovative ultra-wide bandwidth multi-functional phased array hardware. These designs may include, but are not limited to, new non-uniform element designs, feed components and construction, element scaling; non-uniform element and aperture designs (e.g., elements on a curved surface). Non-uniform arrays will be discussed in more detail with reference to FIGS. 2A-3B.

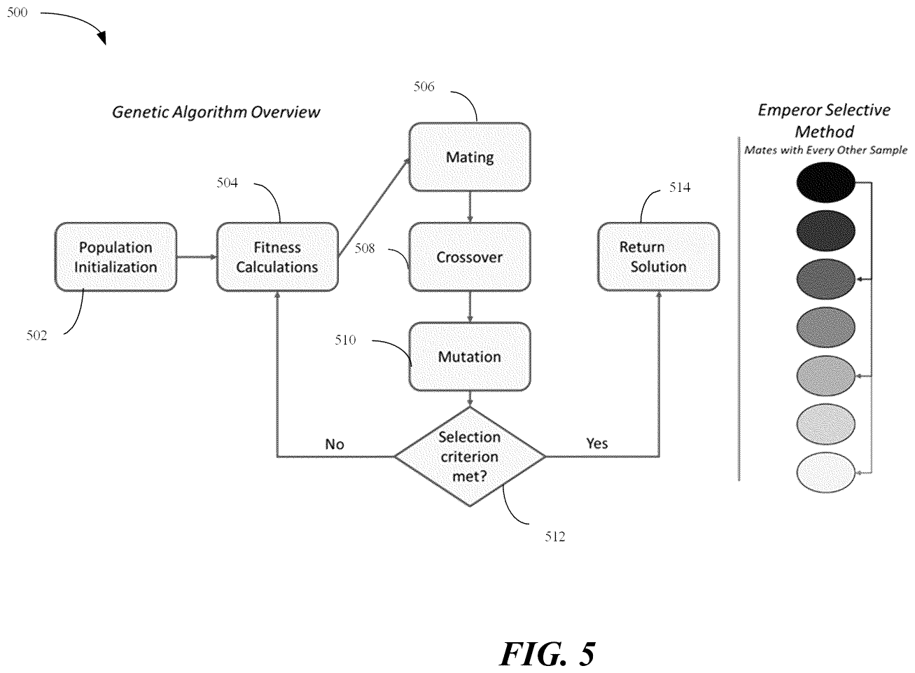

In order to specify weights with non-uniform arrays, control circuitry (e.g., transmit control circuitry 102 or receive control circuitry 110) may utilize one or more weight determination algorithms, such as genetic algorithms. A genetic algorithm example will be discussed in more detail with reference to FIGS. 5-6.

In a non-limiting embodiment, antenna array 104 may be non-uniform because one or more of array elements 105 are damaged or malfunctioning. If one or more of the array elements 105 is damaged or malfunctioning, the signal generated by antenna array 104 may deviate from the specified beam pattern. This deviation may adversely impact signal quality by adding noise or other distortion in the transmitted signal with respect to the specified beam pattern. The decreased signal quality may increase difficulty in extracting information from the signal at a receiver, such as antenna array 108 and/or receive control circuitry 110. In further embodiments, one or more array elements 109 of antenna array 108 may be damaged. This may adversely impact receipt of information from a signal even if the signal does not deviate from a specified beam pattern. In some embodiments, the transmit control circuitry 102 may select weights with one or more weight determination algorithms to compensate for damaged or malfunctioning array elements 105, as will be discussed in more detail with reference to FIG. 6. Additionally, or alternatively, the receive control circuitry 110 may select weights with one or more genetic algorithms to compensate for damaged or malfunctioning array elements 109, as will be discussed in more detail with reference to FIG. 7. Receive control circuitry 110 may also select weights with one or more weight determination algorithms to compensate for signals received from array elements 105.

While the illustrative example of FIG. 1A depicts an antenna array 104 with transmit functionality and an antenna array 108 with receive functionality, this is not intended to be limiting. The same antenna array may have transmit and receive functionality. For example, an antenna array may transmit a signal and receive a reflected signal responsive to the transmitted signal. With reference to an illustrative example, an ultrasound catheter may transmit a signal with one or more elements. This signal may be reflected by cardiovascular structures such as blood vessels or heart tissue, and the reflected signal may be received by the one or more elements. Other applications receiving reflected signals, such as radar applications, are also possible.

As another example, a radar system may transmit a signal with one or more elements of one or more antenna arrays. Each element may have both transmit and receive functionality. The transmitted signal may be reflected off of features of the surrounding environment (e.g., mountains, planes, ships, people, etc.) The reflected signal may then be received by elements of the radar system. In some embodiments, the reflected signal may be received by the same elements that transmitted the signal into the surrounding environment.

As a further example, a wireless communication system, such as a MIMO system or a long term evolution (LTE) system, may transmit a signal from a base station with one or more elements to mobile devices (e.g., smartphones, tablets, etc.) Each element may have both transmit and receive functionality. The base station may then receive signals from mobile devices. In some embodiments, the same elements may both transmit and receive signals.

In addition, a satellite communication system may transmit a signal with one or more elements included in an earth-based station. Each element may have both transmit and receive functionality. The earth based station may also receive signals from satellites. In some embodiments, the same elements may both transmit and receive signals. Additionally, or alternatively, the satellite communication system may transmit a signal with one or more elements of a satellite. The satellite may also receive signals from other satellites and/or the earth based station. In some embodiments, the same elements may both transmit and receive signals.

FIG. 1B illustrates an example system 150 for transmission and/or receipt of signals by an antenna array. The system 150 includes transmit/receive control circuitry 152 associated with an antenna array 154. The system 150 may transmit signal 156 towards a target 158. The transmit/receive control circuitry 152 may then receive a reflected signal 160.

The transmit/receive control circuitry 152 may be configured to perform both transmit and receive functionality. Transmit/receive control circuitry 152 may, for example, perform any of the functionality described above with respect to transmit control circuitry 102 and receive control circuitry 110.

Antenna array 154 may be any suitable antenna array. Antenna array 154 may, for example, be an antenna array described with respect to antenna 104 of FIG. 1A. Antenna array 154 may, for example, be an adaptive array. Antenna array 154 may additionally, or alternatively, be a non-uniform array. Transmit/receive control circuitry 152 may generate weights for the array 154 using one or more weight determination algorithms. such as genetic algorithms. A genetic algorithm example is discussed in more detail with reference to FIGS. 6-7 below.

Target 158 may be any suitable target. For example, system 150 may be implemented as part of an ultrasound catheter. The target 158 may, in further examples, be a cardiovascular structure. As another example, the system 150 may be implemented as part of a radar system. The target 158 may be an object in an environment (e.g., mountains, planes, trains, ships, people, etc.).

The transmit/receive control circuitry 152 may be in electronic communication with antenna array 154 (e.g., through wires/cables, through a network, etc.). The transmit/receive control circuitry 152 may generate a signal 156 with antenna array 154. The transmit control circuitry 152 may, for example, transmit instructions to the antenna array 154 to generate a signal corresponding to a specified beam pattern (e.g., specified by a user). The generated signal as illustrated may be reflected by target 158.

FIGS. 2A-C illustrate various types of transmit and/or receive arrays in accordance with the present disclosure. FIG. 2A illustrates a non-uniform array 200 with elements 202 arranged in accordance with a curved surface transmitting or receiving a signal 204. For example, elements 202 may be mounted on a curved surface. Alternately, elements 202 may be coupled to a planar surface such that the elements 202 form a curved array 200.

Other options are possible. In some examples, non-uniform array 200 may be a conformal array, a deformable array, and the like, or some combination thereof. A conformal array may be a type of antenna array where the individual elements are arranged to conform to a specific surface or shape. A deformable array may be a type of antenna array that can change its shape or configuration in response to external input, operational specifications, and the like, or some combination thereof.

To achieve array 200, the elements 202 may be non-parallel and/or may have non-uniform spacing. Control circuitry, such as transmit control circuitry 102 or receive control circuitry 110 may employ any of the various techniques described herein to account for any non-uniformity of array 200, such as by generating weights to be applied to the elements 202 to improve transmission or receipt of a beam pattern, as will be discussed in more detail with reference to FIGS. 6-7.

FIG. 2B illustrates a uniform linear array 210 including elements 226. FIG. 2C illustrates a non-uniform, sparse linear array 220 including elements 222. Array 220 may include one or more gaps 224 between elements 222. This may contribute to the non-uniformity of array 220. The gaps 224 may be intentional design elements of array 220. For example, the gaps 224 may be included to reduce complexity in signal processing, thereby reducing computational requirements and increasing processing speed. Alternately, the gaps 224 may represent damage to a uniform linear array, such as array 210 of FIG. 2B. For example, gaps 224 may represent array elements that are not functioning as expected for reasons including, but not limited to, damage to the element, damage to components coupled to the element, and/or communication issues between the control circuitry and the element. Gaps 224 may also represent array elements that are missing or inoperable.

Control circuitry, such as transmit control circuitry 102 or receive control circuitry 110 of FIG. 1A or transmit/receive control circuitry 152 of FIG. 1B, may have to account for non-uniformity in sparse arrays by generating weights to improve transmission or receipt of a specified beam pattern. Non-uniformity of sparse arrays may increase challenges in applying weights to the array in accordance with traditional adaptive beamforming techniques. For example, adaptive beamforming techniques may apply a weight to each element of an array to improve the conformity of a transmitted or received signal with a specified beam pattern. However, in one particular example, fewer weights can be applied due to the presence of fewer elements in a sparse array (e.g., array 220 of FIG. 2C) relative to fully populated arrays (e.g., array 210 of FIG. 2B). Accordingly, there may be fewer options in adjusting the weights of the array to improve conformity of a transmitted or received signal with a specified beam pattern. The generation of weights for non-uniform arrays, such as sparse arrays, will be discussed in more detail with regards to FIGS. 6-7.

FIGS. 3A-3B illustrate example distortions in a signal. With reference to FIG. 3A, signal 356 may represent a signal corresponding to a specified beamforming pattern. Additionally, or alternatively, signal 352 may represent a signal from a uniform or approximately uniform array, such as array 210 of FIG. 2B. Signal 352 may represent a signal transmitted or received from a non-uniform array, such as array 220 of FIG. 2C. The presence of gaps 224 in array 220 (FIG. 2C) may cause distortions in signal 352 with respect to signal 356.

With reference to FIG. 3B, signal 306 may represent a signal from a uniform or approximately uniform array, such as array 210 of FIG. 2B. Signal 306 may represent a signal corresponding to a specified beam pattern for transmission and/or receipt. With reference to FIG. 1A, in response to communication from transmit control circuitry 102, the transmit antenna array 104 may transmit a signal corresponding to a first specified beamforming pattern to improve directionality of the signal in a first direction. The first specified beam pattern may be generated by a computing resource or resources of the transmit control circuitry 102, such as a local controller or a remote controller. Transmit control circuitry 102 may determine weights for antenna array 104 to generate a signal corresponding to the first specified beamforming pattern, as will be discussed in more detail with reference to FIGS. 5-7 below. Antenna array 108 may shape a signal arriving at array elements 109 in accordance with a second specified beam pattern. For example, receive control circuitry 110 may determine weights for array elements 109 to receive a signal corresponding to the second specified beamforming pattern. The weights may improve sensitivity of the received signal in a particular direction or directions and/or suppress the contribution of a signal from a particular direction or directions.

Signal 302 may represent a signal transmitted or received by a non-uniform array, such as array 220 of FIG. 2C. Gaps 224 in array 220 may result in distortion of signal 302 with respect to signal 306. Control circuitry, such as transmit control circuitry 102 or receive control circuitry 110, may determine a fitness function representing differences between signal 306 and signal 302. The fitness function may be used in determining weights for antenna arrays, as discussed with reference to FIGS. 5-7 below. In some embodiments, the fitness function may represent the area 304 between signal 302 and signal 306. The area 304 may additionally be limited by cutoff 308, where cutoff 308 may represent a threshold above or below which the fitness function does not need to represent differences between signal 302 or signal 306. The cutoff 308 may, in some examples, be represented by a range of values. For example, a user may specify through a user device a cutoff 308 at −30 dB below which the fitness function may not represent difference between signal 302 and signal 306. Other options are also possible. Cutoff 308 may, for example, represent a range between −30 dB and −35 dB.

Control circuitry, such as transmit control circuitry 102 or receive control circuitry 110, may access the cutoff 308 to determine the fitness function. Alternately, the user may specify a fitness function, and control circuitry, such as transmit control circuitry 102 or receive control circuitry 110, may access the fitness function to determine weights for antenna arrays.

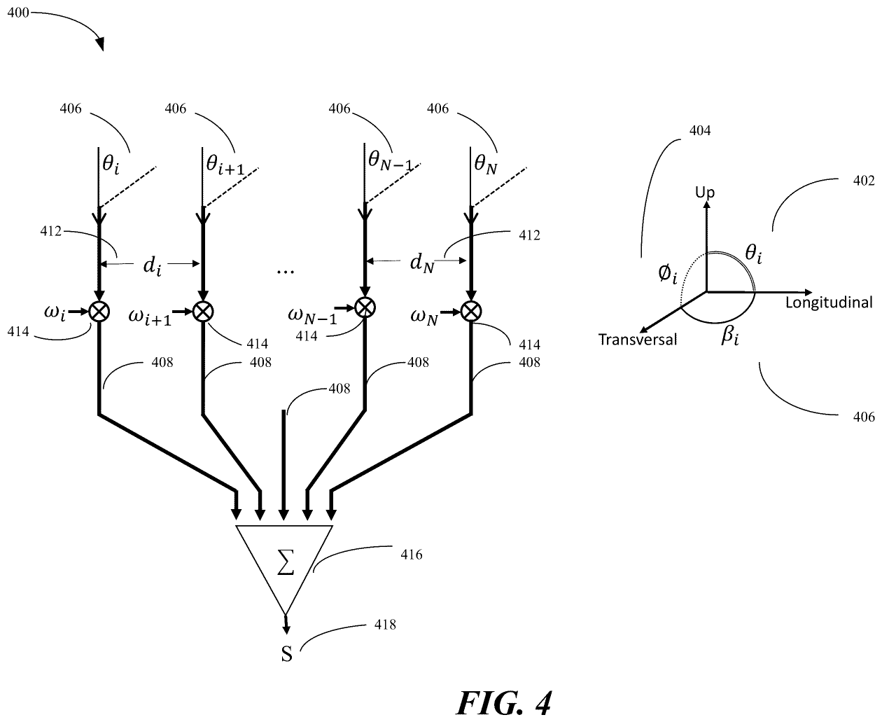

FIG. 4 illustrates example parameters associated with the transmission or reception of signals by an antenna array 400. Signals may be transmitted or received in a manner defined by one or more angles. While FIG. 4 illustrates three potential angles for transmission or receipt of signals, this is not intended to be limiting. Angles for transmission or receipt of signals may be measured between any two planes extending from a given element to a direction of interest. One example angle is angle 402, represented by θ. θ may reflect the angle between a plane extending upwards from a given array element and a plane extending in a longitudinal direction with respect to the given array element. Another potential angles is angle 404 represented by ϕ. ϕ may reflect the angle between a plane extending upwards from a given array element, and a plane extending in a transversal direction with respect to the given array element. Angle 402 and angle 404 may represent elevation angles. Elevation angles may represent a vertical angle measured from a reference plane oriented in a direction of interest. A further potential angle is angle 406, represented by β. β may reflect the angle between a plane extending in a transversal direction with respect to a given element and a plane extending in a longitudinal direction with respect to a given element. Angle 406 may represent an azimuth angle, which may represent a horizontal angle measured from a reference plane oriented in a direction of interest.

Each element 408 in the antenna array 400 may receive signals at different arrival angles. For example, the angle 402 for each element 408 may vary in respect to the angle 402 for each of the other elements 408. Each element 408 in antenna array may also be separated by a distance 412. The distances 412 between each element 408 may be equal. However, in some embodiments, the distances 412 between each element 408 may vary. In other embodiments, a subset of distances 412 may be the equal to each other.

Each element 408 may also be weighted in a different manner, with each element associated with a weight 414, represented by @. Weights may include signal strength (e.g., amplitude) and phase components. Weights for each element may applied to adjust a received signal at each element to improve overall signal quality in the received signal. For example, the weights 414 applied to each element may suppress noise or interference. The weighted contributions from each element may be combined at antenna element 416 to obtain an overall received signal 418. In a non-limiting embodiment, the weighted contribution of each element may be summed at antenna element 416 to obtain an overall received signal 418.

FIG. 5 illustrates an example weight determination method 500 for implementing an algorithm to improve beamforming with respect to non-uniform arrays in accordance with the present disclosure. The determination of weights may be to improve performance of the antenna with respect to a specified purpose including, but not limited to, transmitting a signal from a non-uniform array, receiving a signal from a non-uniform array, receiving a signal with a non-uniform array, or some combination thereof. While discussion with respect to FIG. 5 below describes a genetic algorithm, other algorithms may be used in the determination of weights.

With reference to FIG. 5, genetic algorithms may form part of a machine learning process. A genetic algorithm may be a selection method intended to simulate the process of natural selection, where elements of an initial set are evaluated for fitness for a specified purpose using a fitness function. The most fit elements pass on to the next “generation,” and the process repeats for a specified number of generations. In each generation, the elements may be combined through mating or crossover and/or mutated prior to evaluation for fitness. The resulting output may be used in executing the specified purpose.

A genetic algorithm may include population initialization 502, fitness calculation 504, mating 506, crossover 508, mutation 510, and selection 512. Method 500 is provided as a non-liming example implementation of a genetic algorithm and is not intended to limit the scope of the present disclosure. In some instances, control circuitry, such as transmit control circuitry 102 or receive control circuitry 110 of FIG. 1A, or transmit/receive control circuitry 152 of FIG. 1B, may omit portions of the method, may add additional operations, and/or may rearrange an order of the operations shown. Additionally, method 500 may be repeated until one or more specified thresholds are reached. Method 500 will now be described with respect to an illustrative example of generating weights for an antenna array. This process may also apply to other purposes, such as generating parameters for consideration in generating weights for an antenna array.

Population initialization 502 may include accessing specification of initial elements. Each vector may include a set of weights for an antenna array, such as antenna array 104 or antenna array 108 of FIG. 1A. In some embodiments, a user may provide initial vectors to control circuitry through a user device. Additionally, or alternatively, the control circuitry may generate a set of initial elements. In some embodiments, elements generated by the control circuitry may be based on user input. In some embodiments, these may be based on the output of a prior weight determination genetic algorithm. In a non-limiting example, a user may provide an initial vector including selection of initial weights for each element of an array (e.g., antenna array 104 or antenna array 108 of FIG. 1A). Subsequently, the control circuitry may randomly generate a set of vectors within a percentage range below and above the set of initial weights.

In another non-limiting example, a parameter determination genetic algorithm may generate a set of parameters for use in generating weights. The set of parameters may serve as input to a weight determination genetic algorithm, such as a genetic algorithm for determining beam weights. For example, the parameter determination genetic algorithm may select values for parameters including, but not limited to, initial population size, number of generations, crossover rate, mutation rate, or termination criteria. The parameters selected may be within thresholding criteria including but not limited to, a threshold number of generations, thresholds relating to the crossover rate, a threshold relating to the mutation rate, a threshold relating to termination criteria, and the like, or some combination thereof. The control circuitry may use these parameters as input for the weight determination genetic algorithm, where the weight determination genetic algorithm uses the parameters from the parameter determination genetic algorithm as it generates weights for each element of the array.

At fitness calculation 504, fitness of each of the initial vectors may be determined. In some embodiments, control circuitry may determine fitness through implementation of a fitness function (also referred to as a “cost function”). The fitness function may measure the difference between power and directivity of a waveform representing a specified beam pattern and power and directivity of a waveform corresponding to a signal transmitted with the array weighted in accordance with one of the initial vectors. In some embodiments, the fitness for each element of the initial elements may be calculated as the area between a plot a waveform corresponding to a specified beam pattern (e.g., a power plot, a directivity plot, etc.) and a plot of a waveform corresponding to a signal transmitted with the element of the initial elements under evaluation (e.g., a power plot, a directivity plot, etc.). In some embodiments, only a sub-portion of the plots of the waveforms may be considered. For example, the sub-portion of the over or under a specified threshold may be considered in evaluating fitness. The specified threshold may correspond to an acceptable level for side lobe suppression.

With reference to FIG. 3B, signal 306 may be a waveform corresponding to a specified beam pattern. Signal 302 may be a waveform corresponding to a signal transmitted with the array weighted in accordance with one of the initial vectors. In a non-limiting embodiment, −30 dB may be an acceptable value for side lobe suppression. Accordingly, control circuitry may evaluate fitness based on the area 304 above cutoff 308, where cutoff 308 as illustrated is −30 dB. Other options are possible, cutoff 308 may, in some examples, be a cutoff range between −30 dB and −35 dB.

At mating 506, the control circuitry may apply a selective method to select a subset of the initial vectors as “parents.” With reference to FIG. 5, the selective algorithm may be an emperor selective method. The emperor selective method is a parent selection method and specifically a mating scheme. In the emperor selective method, every other vector is combined with a highest ranked vector, based on fitness and preservation of variance within the selected vectors. Other selection methods are possible. These include, but are not limited to, fitness proportional selection, tournament selection, and/or stochastic universal sampling. Fitness proportional selection may include selecting vectors in accordance with their determined fitness. For example, an individual with higher fitness may have a higher chance of being selected. Tournament selection may include first selecting a random subset of the initial vectors and subsequently selecting the vector with the highest fitness within that subset. This process may be repeated to select multiple parents. Stochastic universal sampling may random selection of multiple vectors at evenly spaced intervals.

At 508, the control circuitry may generate “offspring” of the “parents” selected at mating 506, using a crossover method such as simulated binary crossover (SBC). SBC may use a probability density function to generate “offspring” with values either close to or farther away from the “parents” depending on the value selected for a distribution index, η_{c}. SBC may be implemented using equation (1) below,

$${x}_{1}^{new} = 0.5 [ ( 1 + λ ) {x}_{1} + ( 1 - λ ) {x}_{2} ] {x}_{2}^{new} = 0.5 [ ( 1 - λ ) {x}_{1} + ( 1 + λ ) {x}_{2} ] \qquad ( 1 )$$

where
   x₁ and x₂ are the parents
   random number, u∈[0,1)

$$λ = \{ \begin{matrix}{( 2 u )}^{\frac{1}{{η}_{c} + 1}} , & if u \leq 0.5 \\ {( \frac{1}{2 ( 1 - u} )}^{\frac{1}{{η}_{c} + 1}} , & otherwise\end{matrix}$$

distribution parameter, η_{c}
   larger value for η_{c} generates children closer to parent values
   conversely, smaller η_{c} generates children farther away from parent values.

At mutation 510, the control circuitry may “mutate” the offspring using a mutation function. Mutation functions may include, but are not limited to, non-uniform mutation or Gaussian mutation.

Non-uniform mutation may be represented by equation (2), below.

$${x}_{new} = x + τ ( {x}_{max} - {x}_{min} ) ( 1 - {r ( 1 - \frac{t}{{t}_{max}} )}^{b} ) \qquad ( 2 )$$

where
   τ is −1 or 1, selected with a probability of 0.5.
   random number, r∈[0,1]
   maximum number of generations or runs, tₘₐₓ
   current generation number, t
   design parameter determining degree of nonuniformity, b

Gaussian mutation may be represented by equation (3), below:

$$p ( {x}_{i}^{′} ; {x}_{i} ; {σ}_{i} ) = \{ \begin{matrix}\frac{\frac{1}{{σ}_{i}} ϕ ( \frac{{x}_{i}^{′} - {x}_{i} )}{{σ}_{i}} )}{Φ ( \frac{{b}_{i} - {x}_{i}}{{σ}_{i}} ) - Φ ( \frac{{a}_{i} - {x}_{i}}{{σ}_{i}} )} , & if {a}_{i} \leq {x}_{i}^{′} \leq {b}_{i} \\ 0 , & otherwise\end{matrix}$$

where
   the probability function of the standard normal distribution is

$$ϕ ( ζ ) = \frac{1}{\sqrt{2 π}} exp ( - \frac{1}{2} {ζ}^{2} )$$

the cumulative distribution function is Φ(·)
σᵢ is the mutation strength parameter for each variable related to the bounds aᵢ and bᵢ

If xᵢ∈[aᵢ, bᵢ] is a real variable the Gaussian mutation operator causes xᵢ to become a neighboring value using the probability function.

At selection 512, the control circuitry may select a subset of the “offspring” using a selection method. Selection methods may include, but are not limited to, fitness proportional selection, tournament selection, and/or stochastic universal sampling. Fitness proportional selection may include selecting vectors in accordance with their determined fitness. For example, an individual with higher fitness may have a higher chance of being selected. Tournament selection may include first selecting a random subset of the initial vectors and subsequently selecting the vector with the highest fitness within that subset. This process may be repeated to select multiple offspring. Stochastic universal sampling may random selection of multiple vectors at evenly spaced intervals.

At output 514, the control circuitry may output the “offspring” as results. Additionally, or alternatively, the method 500 may repeat until the “offspring” satisfy one or more specified thresholds. Specified thresholds may include, but are not limited to, a specified number of generations (e.g., repeats of method 500), or a specified acceptable fitness value. Once the specified thresholds are met, the control circuitry may output the “offspring” as results. In a non-limiting embodiment, a receive control circuitry (e.g., receive control circuitry 110 of FIG. 1A) may apply the results generated with one or more genetic algorithms as weights to elements of an array (e.g., antenna array 108 of FIG. 1A). In another non-limiting embodiment, a transmit control circuitry (e.g., transmit control circuitry 102 of FIG. 1A), may apply the results generated with one or more genetic algorithms as weights to elements of an array (e.g., antenna array 104 of FIG. 1A). Applications of algorithm-generated weights to elements of an array is described in more detail with reference to FIG. 6.

FIG. 6 illustrates an example method 600 for transmitting a specified beam pattern. The method begins at block 602. In some instances, control circuitry, such as transmit control circuitry 102 or receive control circuitry 110 of FIG. 1A, may omit portions of the routine, may add additional operations, and/or may rearrange an order of the operations shown.

The method 600 begins at block 602. The method 600 may begin on connection of the control circuitry to an array (e.g., antenna array 104 or antenna array 108 of FIG. 1A). In further embodiments, the method 600 may generate a set of weights to apply to a newly connected array. However, in some embodiments, an initial set of weights may be generated for a newly connected array with apodization methods, which are described in more detail with reference to FIG. 7.

The method 600 may also begin on detection of array damage or malfunction. For example, the control circuitry may access data from one or more sensors. Sensors may include, but are not limited to optical fiber sensors, current sensors, voltage sensors, or acoustic sensors. The data may include, but is not limited to, data relating to electrical characteristics of each element of the array (e.g., impedance). Based on sensor data, the control circuitry may determine that the array is damaged or malfunctioning and initiate method 600. The control circuitry may also detect damage or malfunction based on comparison of a received or transmitted signal to a specified beamforming matter. The control circuitry may also access in indication that the array is damaged. The indication may be from a user or from an external service. For example, a damage detection service may transmit an indication to the control circuitry that an array or arrays in communication with the control circuitry are damaged or malfunctioning. As another example, the damage detection service may store an indication that an array or arrays are damaged in a data store. The control circuitry may access this data store and determine that an array or arrays in communication with the control circuitry are damaged or malfunctioning.

Additionally, or alternatively, the method 600 may repeat at intervals. For example, the array may be an adaptive array, and the method 600 may repeat at specified intervals to adaptively adjust weights to responsive to changing conditions. Changing conditions may include, but are not limited to, weather, other variations in the environment, signal interference, changes in the array (e.g., damage, layout, orientation, etc.). The control circuitry may detect changing conditions based on feedback from the array. Additionally, or alternatively, a user may specify the intervals through a user to meet performance criteria including, but not limited to maximizing SNR, minimizing interference, or improving signal conformity with a specified beam pattern.

At block 604, the control circuitry may access a specified beam pattern. The specified beam pattern may be provided by a user through a user device. However, the control circuitry may also generate the specified beam pattern. For example, the control circuitry may generate a specified beam pattern to improve signal quality and/or direct a signal towards a specific location.

At block 606, the control circuitry may determine weights for an array (e.g., antenna array 104 of FIG. 1A). Weights may be determined for each element of the array. The control circuitry may determine weights for the array using a weight determination genetic algorithm. With respect to the illustrative example of FIG. 5, at population initialization 502, the control circuitry may determine an initial population as input for the second genetic algorithm. The initial population for the second genetic algorithm may include vectors, where each vector includes a set of potential weights for the array. The vectors in the initial population may be based on user input. For example, the user may provide a set of initial vectors as input. The control circuitry may expand on this initial input by calculating vectors with values a certain percentage above or below the values of each vector of the set of initial vectors. As another example, the user may provide a first vector as input, and the control circuitry may generate a set of initial vectors based on the first vector by calculating vectors with values a certain percentage above or below the values of the first vector.

At fitness calculation 504, the control circuitry may evaluate the vectors using a second fitness function. The second fitness function may be configured to measure a difference between a specified beam pattern and a pattern generated with weight for each vector. The second fitness function may also be specified by a user through a user device. After determination of fitness at fitness calculation 504, “offspring” vectors may be produced as a result of mating 506, crossover 508, and mutation 510. If selection criteria including, but not limited to, fitness level are met by the “offspring” at selection 512. The weight determination genetic algorithm may output the “offspring” as weights to be applied to the array.

At block 608, the control circuitry may determine values for parameters subject to additional analysis with a parameter determination algorithm. The parameter determination algorithm may be, but is not limited to, a least mean squares algorithm, an apodization method, a genetic algorithm, or the like. In some examples, where the first algorithm is a genetic algorithm, parameters may include, but are not limited to, initial population size, a crossover rate, a mutation rate, and/or termination criteria. With reference to the illustrative example of FIG. 5, the control circuitry may determine a range of values for specified parameters to provide to a first genetic algorithm at population initialization 502. Additionally, or alternatively, the control circuitry may determine a range of values for specified parameters. For example, a user may provide an initial value for each of the specified parameters, and the control circuitry may determine a range of values for each specified parameter by within a percentage below and/or a percentage above its initial value. The control circuitry may also determine a set of vectors (also referred to as “chromosomes”) as input for the first genetic algorithm, where vector includes a value for each of the specified parameters.

At fitness calculation 504, the control circuitry may evaluate the vectors using a first fitness function. The first fitness function may be configured to determine fitness of each vector to serve as input to a weight determination genetic algorithm, where the weight determination genetic algorithm determines weights for the antenna array. Additionally, or alternatively, the fitness function may be configured to measure a difference between a specified beam pattern and patterns that would likely with weights generated by the second genetic algorithm. In some embodiments, the first fitness function may be based on results from previous runs of method 600. Additionally, or alternatively, the first fitness function may also be specified by a user through a user device. After determination of fitness at fitness calculation 504, “offspring” vectors may be produced as a result of mating 506, crossover 508, and mutation 510. If selection criteria including, but not limited to, fitness level are met by the “offspring” at selection 512. The weight determination genetic algorithm may output the “offspring” as results to the parameter determination genetic algorithm.

At block 610, the control circuitry, may output the determined weights to the array. To output the determined weights to the array, the control circuitry may modify the signal provided to each element of the array for transmission to be modified in accordance with the determined weight for that element. At block 612, the control circuitry may cause the array to transmit a signal. The generated signal may correspond to the specified beam pattern. The routine may end at block 614.

The method 600 may be repeated to adjust weights for the array. For example, the method 600 may repeat at intervals separated by a specified time. Additionally, or alternatively, method 600 may repeat in response to external input. External input which may result in repeating method 600 may include, but is not limited to, input indicating that an array is damaged or malfunctioning or input relating to changed conditions (e.g., signal interference, weather, etc.)

Additionally, or alternatively, apodization methods may be implemented to adjust weights in the array. For example, one or more genetic algorithms may be used to generate weights for transmission of a signal through an array, and apodization methods may be used to generate weights for receipt of a signal through the array. While FIG. 6 describes a method 600 for transmitting a specified beam pattern, this is not intended to be limiting. In some embodiments, one or more genetic algorithms may be used to generate weights for receipt of a signal through an array.

Apodization methods may be used to generate weights for transmission or receipt of a signal through the array. In other embodiments, one or more genetic algorithms may be used to generate weights for transmission of a signal through a first array, and apodization methods may be used to generate weights for receipt of a signal through a second array. Apodization methods are discussed in more detail with reference to FIG. 7.

FIG. 7 illustrates an example method 700 for processing a signal. Time delayed RF data 702 may be received by an antenna array, such as antenna array 108 of FIG. 1A or antenna array 400 of FIG. 4. In some embodiments, time delayed RF data 702 may represent a sampled version of the received signal. Alternately, time delayed RF data 702 may be sampled from a transmitted signal.

Control circuitry, such as transmit control circuitry 102 or receive control circuitry 110 of FIG. 1A, or transmit/receive control circuitry 152 of FIG. 1B may duplicate the signal and process the signal with multiple different methods 704A-C. Methods 704A-C may include apodization methods to reduce side lobe levels in a transmitted or received signal (e.g., signal 106 of FIG. 1A). Apodization techniques, including application of various envelope generation and selection techniques may also be used in addition to weight selection with alternatively or in addition to genetic algorithms. Apodization is a technique to improve communication of a specified signal/or image.

Apodization refers to method to shape a received signal by adjustment of the signal strength (e.g., amplitude) and phase of a received signal using one or more weights. The transmitted or received signal may be sampled prior to apodization, where the sampling rate influences the result of apodization. Apodization methods may employ one or more windowing techniques to highlight peaks in received or transmitted signals, as will be discussed in more detail below with respect to methods 704A-C. Windowing functions may be multiplied in an elementwise fashion with a signal to shape its characteristics. Windows may be applied prior to or subsequent to a fourier transform of the signal.

Apodization may be linear or non-linear. Linear apodization methods may have substantial trade-offs between side lobe reduction and signal quality. For example, linear apodization methods may applied to applications including synthetic aperture radar (SAR) processing. Linear apodization may be applied through a bᵢ-dimensional weighting in the range-Doppler domain, which may reduce spectral leakage, spreading of signal energy across frequencies, at the expense of resolution loss. Windowing techniques for linear apodization methods may include, but are not limited to, kaiser windows, “cosine on pedestal windows” or rectangular windows. “Cosine on pedestal windows” may combine a cosine window with a constant pedestal. The constant pedestal may serve to maintain unity gain to avoid bias in overall signal power.

Rectangular windows may apply a constant amplitude of a signal within the window and zero the amplitude outside of the window. Rectangular windows may have narrower main-lobe width but higher side lobe widths than other window functions. A rectangular window function in the time domain may be represented by equation (4) below:

$${w}_{r} ( n ) = 1 , 0 , ( 0 \leq \vert n \vert \leq \frac{N}{2} ) \qquad ( 4 )$$

Where N is the total number of samples and n is the sample number in the time domain.

The discrete Fourier transform (DFT) of the rectangular window function may be represented by equation (5) below, where k is the sample number in the frequency domain.

$${W}_{r} ( k ) = exp ( - j \frac{N - 1}{2} k ) ( \frac{sin \frac{Nk}{2}}{sin \frac{k}{2}} ) , \\ ( k = - π , … , - \frac{2 π}{N} , 0 , \frac{2 π}{N} , … , π ) \qquad ( 5 )$$

Kaiser windows may have a parameterized shape, associated with a shape parameter. A user may utilize the shape parameter to control the trade-off between the width of the main lobe of a signal and side lobes. A kaiser window function in the time domain may be represented by equation (6) below.

$${w}_{K} ( n ) = \frac{{I}_{0} ( π {α}_{K} \sqrt{1. - {( \frac{2 n}{N} )}^{2} )}}{{I}_{0} ( π {α}_{K} )} , ( 0 \leq \vert n \vert \leq \frac{N}{2} ) \qquad ( 6 )$$

Where α_{K} is a control parameter and I₀(X) is a zero order modified Bessel function represented by:

$${I}_{0} ( X ) = {\sum }_{k = 0}^{∞} {( \frac{{( \frac{x}{2} )}^{k}}{k !} )}^{2}$$

The DFT of the Kaiser window function represented by equation (7) below.

$${W}_{K} ( k ) = \frac{N}{{I}_{0} ( {α}_{K} π )} \frac{sinh ( \sqrt{{α}_{K}^{2} {π}^{2} - {( \frac{Nk}{2} )}^{2} )}}{\sqrt{{α}_{K}^{2} {π}^{2} - {( \frac{Nk}{2} )}^{2}}} , \\ ( k = - π , … , - \frac{2 π}{N} , 0 , \frac{2 π}{N} , … , π ) \qquad ( 7 )$$

The control circuitry may use a rectangular window for apodization methods 704A-C on segments of the received time delayed RF data 702. For example, the apodization method #1 704A may be a rectangular window used to filter and remove side-lobe frequencies within the time delayed RF data 702. Additionally, or alternatively, the apodization method #1 704A may be a rectangular window used to highlight peaks of the received time delayed RF data 702.

Non-linear apodization methods may include, but are not limited to, Dolph-Chebyshev windows or spatially variant apodization (SVA). Dolph-Chebyshev windows or spatially variant apodization (SVA) may have control parameters for both the main lobe width and side lobe level. Non-linear apodization methods may generate a different weighting function for multiple portions of a received signal or image. With reference to synthetic aperture radar (SAR) processing, Non-linear apodization methods may reduce leakage without significantly impacting resolution. Results from application of Non-linear apodization methods may be improved if signals are sampled at the Nyquist sampling rate, which refers to a minimum sampling rate required to accurately represent a signal without aliasing.

As discussed, a nonlinear apodization methods may include SVA, where SVA may include, but is not limited to, 3-tap SVA, 5-tap SVA or 9-tap SVA. A “tap” may refer to a weighting function or coefficient applied to a signal. Accordingly, 5-tap apodization may refer to multiplying the signal by an antenna array, such as antenna array 108 of FIG. 1A or antenna array 400 of FIG. 4, by 5 different coefficients or weights. 9-tap apodization may refer to multiplying the signal by an antenna array, such as antenna array 108 of FIG. 1A or antenna array 400 of FIG. 4, by 9 different coefficients or weights. In 5-tap or 9-tap apodization constraints may be expressed in a set of linear inequations, where inequations are statements that an inequality holds between values. An inequality region may be determined bounded by the boundary of the inequations in an n-dimensional space. This space may be 5 dimensions in 5-tap apodization and 9 dimensions in 9-tap apodization. In some situations, a null point which reduces or eliminates side-lobes may be determined through use of a side-lobe reduction or elimination function. Additionally, or alternatively, the null point may be determined by searching the inequality region. The null point may also be determined The control circuitry may use a type of SVA, such as 2-tap SVA, 5-tap SVA, 9-tap SVA for apodization methods 704A-C. For example, apodization method #2 704B may be 5-tap SVA and apodization method #3 704C may be 9-tap SVA. Other apodization methods may also be used for apodization methods 704A-C.

After processing of the signal with methods 704A-C, the control circuitry may detect envelopes within each processed signal at envelope detection 706, where envelopes outline the peaks in the received time delayed RF data 702 Envelopes may be selected to minimize or suppress side-lobes in a generated or received signal. This may improve conformity with a specified beam pattern and/or improve overall signal quality in a received or transmitted signal. After envelope detection, the control circuitry may then assemble a signal of minimum values, which may have reduced side lobes as compared to the original time delayed RF data 702. For example, the control circuitry may combine the signals with log compression 710. Subsequently, the control circuitry may be displayed at 712.

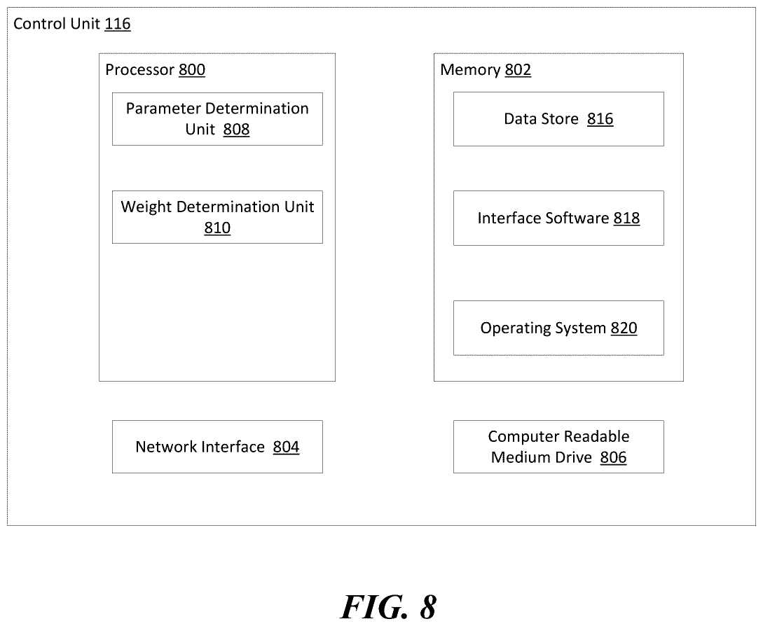

FIG. 8 schematically depicts example control circuitry 116. Control circuitry 116 may be a local or remote computing resource for control circuitry, such as transmit control circuitry 102, receive control circuitry 110 of FIG. 1A and/or transmit/receive circuitry 152 of FIG. 1B. However, the control circuitry 116 may represent a computing resource of another control circuitry. For example, the control circuitry 116 may represent a computing resource of transmit/receive control circuitry in electronic communication with both a transmit array (e.g., antenna array 104 of FIG. 1A) and a receive array (e.g., antenna array 108 of FIG. 1A) As another example, the control circuitry 116 may be in electronic communication with a transmit/receive array (e.g., transmit/receive array 154 of FIG. 1B).

The general architecture of the control circuitry 116 includes an arrangement of computer hardware and software components that may be used to implement aspects of the present disclosure. It will be understood that control circuitry 116 may include more, fewer, and/or different components than those shown with reference to FIG. 8. For example, in some embodiments, the processing functionality performed by the processor 800 may be incorporated into other components, such as the parameter determination 808 or the weight determination 810. Additionally, processor 800 may include more than one processor.

The parameter determination 808 may be used to generate parameters within thresholding criteria as discussed with reference to FIGS. 6-7 above. The parameter determination 808 may access instructions from memory 802, such as input for a genetic algorithm.

The weight determination 810 may be used to generate weights for antenna array(s), such as antenna array 104 or antenna array 108 of FIG. 1A. The weight determination 810. The weight determination 810 may access instructions from memory 802, such as input for a genetic algorithm.

The control circuitry 116 may also include a network interface 804. The network interface 804 may provide connectivity to one or more networks or computing systems. For example, the control circuitry 116 may be remotely connected to one or more antenna arrays through a network. Alternately, in some embodiments, the parameter determination 808 or the weight determination 810 may be separate from the control circuitry 116. In further embodiments, the network interface 804 may provide connectivity to the parameter determination 808 or the weight determination 810.

The computer readable medium drive 806 can be used to provide a direct connection to the control circuitry 116. For example, a user may connect to the control circuitry 116 with a user device with computer readable medium drive 806. This connection can be used to communicate with the control circuitry 116 and/or provide maintenance for the control circuitry 116. Antenna array(s), such as antenna array 104 or antenna array 108 of FIG. 1A. In some embodiments, the computer readable medium drive 806 can be used in updating algorithm(s) used in determining weights for antenna array(s). For example, updates may include, but are not limited to, changing the number of generations use for in a genetic algorithm or changing the fitness function used in the genetic algorithm(s). As another example, a user may connect to control circuitry 116 with a user device through network interface 804.

The memory 802 may include computer program instructions by a processor 800 in order to implement one or more embodiments. The memory 802 generally includes RAM, ROM or other persistent or non-transitory memory. The memory 802 may store an operating system 820 that provides computer program instructions for use by the processor 800 in the general administration and operation of control circuitry 116. In some embodiments, the memory 802 may include storage for interface software 818. This may include information necessary for communication with one or more network connected devices through network interface 804.

The control circuitry 116 can further include a data store 816 for storing parameters generated by parameter determination 808. Additionally, or alternatively, the data store 816 may store weights generated by weight determination 810.

### Terminology

All of the methods and tasks described herein may be performed and fully automated by a computer system. The computer system may, in some cases, include multiple distinct computers or computing devices (e.g., physical servers, workstations, storage arrays, cloud computing resources, etc.) that communicate and interoperate over a network to perform the described functions. Each such computing device typically includes a processor (or multiple processors) that executes program instructions or modules stored in a memory or other non-transitory computer-readable storage medium or device (e.g., solid state storage devices, disk drives, etc.). The various functions disclosed herein may be embodied in such program instructions or may be implemented in application-specific circuitry (e.g., ASICs or FPGAs) of the computer system. Where the computer system includes multiple computing devices, these devices may, but need not, be co-located. The results of the disclosed methods and tasks may be persistently stored by transforming physical storage devices, such as solid-state memory chips or magnetic disks, into a different state. In some embodiments, the computer system may be a cloud-based computing system whose processing resources are shared by multiple distinct business entities or other users.

Depending on the embodiment, certain acts, events, or functions of any of the processes or algorithms described herein can be performed in a different sequence, can be added, merged, or left out altogether (e.g., not all described operations or events are necessary for the practice of the algorithm). Moreover, in certain embodiments, operations or events can be performed concurrently, e.g., through multi-threaded processing, interrupt processing, or multiple processors or processor cores or on other parallel architectures, rather than sequentially.

The various illustrative logical blocks, modules, routines, and algorithm steps described in connection with the embodiments disclosed herein can be implemented as electronic hardware, or combinations of electronic hardware and computer software. To clearly illustrate this interchangeability, various illustrative components, blocks, modules, and steps have been described above generally in terms of their functionality. Whether such functionality is implemented as hardware, or as software that runs on hardware, depends upon the particular application and design conditions imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set” and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A computer-implemented method comprising:
obtaining a beam pattern to be transmitted by an antenna array;
determining, using one or more machine learning algorithms, parameters for selecting weights for the antenna array; and
determining, using the one or machine learning algorithms, one or more weights for the antenna array, wherein each determined weight impacts signal output by an element of the antenna array; and
applying the determined weights to control circuitry of the antenna array.

2. The computer-implemented method of claim 1, wherein the one or more machine learning algorithms include a weight determination genetic algorithm and a parameter determination genetic algorithm, wherein the weight determination algorithm determines the one or more weights for the antenna array, and wherein the parameter determination genetic algorithm determines the parameters for selecting weights.

3. The computer-implemented method of claim 2, further comprising providing input to weight determination genetic algorithm including mutation, crossover, or number of generations to determine the weights.

4. The computer-implemented method of claim 2, further comprising providing input to the parameter determination genetic algorithm including mutation, crossover number of generations to determine parameters meeting thresholding criteria.

5. The computer-implemented method of claim 1, further comprising causing the antenna array to transmit a signal in accordance with the determined weights.

6. The computer-implemented method of claim 5, further comprising:
receiving the signal with a second antenna array comprising one or more elements;
applying at least one windowing technique to the received signal;
selecting a minimum value; and
displaying the received signal.

7. The method of claim 6, wherein at least one element of the second antenna array is damaged.

8. The computer-implemented method of claim 1, wherein determining parameters comprises selecting a subset of parameters for consideration including at least one of minimum side lobe levels, maximum side lobe levels, null depth, beamwidth, signal to noise ratio, signal strength, and interference.

9. The computer-implemented method of claim 8, wherein determining parameters comprises determining a target range for the selected subset of parameters.

10. A communication system comprising:
a first antenna array comprising one or more elements, wherein at least one element of the first antenna array non-uniform with respect to other elements of the one or more elements; and
control circuitry in communication with the antenna array, wherein the control circuitry is configured to dynamically adjust weights for the first antenna array to achieve transmission of a specified beam pattern at least by:
determining weights for the first antenna array using a weight determination algorithm; and
determining parameters for selecting weights of the first antenna array using a parameter determination algorithm.

11. The system of claim 10, wherein the weight determination algorithm and the parameter determination algorithm comprise genetic algorithms.

12. The system of claim 10, further comprising:
a second antenna array comprising one or more elements; and
second control circuitry in communication with the second antenna array, wherein the second control circuitry is configured to dynamically adjust weights for the second antenna array to receive signals from the first antenna array.

13. The system of claim 10, wherein the first antenna array is a non-uniform linear antenna array.

14. The system of claim 10, wherein the first antenna array is a sparse antenna array.

15. The system of claim 10, wherein the first antenna array is conformal and deformable.

16. The system of claim 10, wherein the one or more elements of the first antenna array are equidistant.

17. A computer-implemented method comprising:
receiving a signal with an antenna array, wherein at least one element of the antenna array behaves in a manner that deviates from an expected behavior;
determining weights to apply to the antenna array;
interpreting received signal by at least:
applying an apodization method to the received signal; and
displaying the received signal.

18. The computer-implemented method of claim 17, wherein applying an apodization method comprises applying a linear apodization method.

19. The computer-implemented method of claim 17, wherein applying an apodization method comprises applying a non-linear apodization method.

20. The computer-implemented method of claim 19, wherein applying a non-linear apodization method comprises at least one of dual-apodization tri-apodization, or quad-apodization.

21. The computer-implemented method of claim 20, wherein applying the non-linear apodization comprises:
applying a plurality of different windowing techniques to obtain a plurality of output signals; and
selecting a minimal carrier-to-noise (CNR) value of the plurality of output signals.

22. The computer-implemented method of claim 21, wherein applying the plurality of windowing techniques comprising at least one of a rectangular window, a Dolph-Chebyshev window, and a Kaiser Window.

23. The computer-implemented method of claim 17, further comprising:
receiving an indication that a second antenna array, comprising one or more elements, is non-uniform;
obtaining a specified beam pattern to be received by the antenna array;
receiving a signal including the specified beam pattern;
determining weights for the non-uniform antenna array with a second genetic algorithm, wherein the each determined weight impacts the signal received by an element of the antenna array;
determining parameters for selecting weights for the antenna array with a parameter determination genetic algorithm; and
applying the determined weights to the second antenna array.

24. A communication system comprising:
an antenna array comprising one or more elements, wherein at least one element of the antenna array is damaged or non-ideal; and
control circuitry in communication with the antenna array, wherein the control circuitry is configured to dynamically adjust weights for the antenna array for receiving a signal by at least:
applying an apodization method to the received signal; and
displaying the received signal.

25. The system of claim 24, wherein the control circuitry is further configured dynamically adjust weights for the antenna array by applying one or more weight determination algorithms, wherein the one or more weight determination algorithms comprise one or more machine learning techniques such as genetic algorithms.

26. The system of claim 24, further comprising:
a second antenna array comprising one or more elements; and
second control circuitry in communication with the second antenna array, wherein the second control circuitry is configured to dynamically adjust weights for the second antenna array to receive signals from the antenna array.

27. The system of claim 24, wherein the antenna array is a linear antenna array.

28. The system of claim 24, wherein the antenna array is a sparse antenna array.

29. The system of claim 24, wherein the antenna array is conformal and deformable.

30. The system of claim 24, wherein the one or more elements of the antenna array are equidistant.
